(19) United States
(12) Patent Application Publication
(10) Pub. No.: US 2018/0344439 A1
(43) Pub. Date: Dec. 6, 2018

(54) PROSTHODONTIC DEVICE

(71) Applicants: CHUNG-CHIH TSENG, KAOHSIUNG CITY (TW); YAO-TE PENG, TAOYUAN CITY (TW)

(72) Inventors: CHUNG-CHIH TSENG, KAOHSIUNG CITY (TW); YAO-TE PENG, TAOYUAN CITY (TW)

(21) Appl. No.: 15/797,042

(22) Filed: Oct. 30, 2017

(30) Foreign Application Priority Data
Jun. 5, 2017 (TW) 106208021

(51) Int. Cl. A61C 13/30

(52) U.S. Cl. CPC A61C 13/30

(57) ABSTRACT

A prosthodontic device applicable to the remainder of a root of a tooth that has received complete endodontic therapy includes a post and a core integrally formed with one end of the post. The post has a post body and a connection unit formed on the surface of the post body. The core has a head to sit on the top end of the remainder of the root of the tooth and at least one shoulder formed on the head. The largest diameter of the core is larger than the largest diameter of the post body of the post. The prosthodontic device enables rapid completion of tooth preservation and restoration after endodontic therapy.

### BACKGROUND OF THE INVENTION

### 1. Technical Field

The present invention relates to a prosthetic device for dental restoration and more particularly to a prosthesis assembly designed to facilitate the restoration of the dental crown after endodontic therapy (known as root canal therapy).

### 2. Description of Related Art

Teeth are used for biting and chewing. Failure to clean teeth properly invites dental caries and/or periodontitis. The dental crown may also break when hit by accident.

Nowadays, the treatment of tooth decay generally involves grinding a decayed tooth with a high-speed dental drill to remove a portion of the tooth and then restoring the tooth with a filling or restorative material. In cases of severe tooth decay that has invaded the pulp chamber, the nerve in the afflicted tooth must be extracted, followed by regular endodontic therapy, which enlarges and cleans the root canal(s) of the tooth and then seals the root canal(s) with gutta-percha in an aseptic manner. Only if no more lesion is found during a certain observation period can the tooth be restored with a prosthetic crown. Tooth restoration with a prosthetic crown generally includes making a dental impression with a conventional cast dental post in a/the root canal, preparing a prosthetic crown based on the dental impression, and cementing the crown to the dental post. A conventional cast dental post is typically a smooth post with a core integrally formed with one end of the post. This post-and-core assembly provides support in the root canal and forms the main structure of the restored tooth, allowing a prosthetic crown, made from a precise dental impression, to be bonded to the core adhesively.

Moreover, a conventional dental post, be it prefabricated or cast, requires adhesive applied to the post surface in order to be bonded to the wall of a root canal that has received complete endodontic therapy. Formed by adhesive alone, however, the bond between such a dental post and the wall of a root canal that has received complete endodontic therapy is rather weak, meaning the stability of the dental post is low. In fact, the bond is likely to fail due to long-term application of the occlusal force. Should the dental post get loose, the joint between the post and the core may break as a result of stress concentration.

### BRIEF SUMMARY OF THE INVENTION

One objective of the present invention is to provide a prosthesis assembly, or prosthodontic device, for use after endodontic therapy to facilitate the restoration of the dental crown. It is desirable that the prosthodontic device features a high bonding strength between itself and the wall of a root canal having received complete endodontic therapy and therefore has a longer service life than its prior art counterparts.

The present invention provides a prosthodontic device suitable for use with a root canal that has received complete endodontic therapy. The prosthodontic device includes a post and a core. The post has a post body and a connection unit. The connection unit is formed on the surface of the post body and is configured to couple with the wall of an insertion hole in the root canal. The core is integrally formed with one end of the post and has a head and at least one shoulder. The head is configured to sit on the top end of a sound root of the remainder of a natural tooth, and the shoulder is formed on the head. The largest diameter of the core must not be larger than the width of the cross section of the underlying root.

The prosthodontic device of the present invention is so designed that the connection unit formed on the surface of the post body of the post can couple with the wall of the insertion hole in a root canal having received complete endodontic therapy, and that the core can sit on the top end of a sound root of the tooth having received complete endodontic therapy, allowing a dental impression to be taken directly of the core in order to make a prosthetic dental crown, without having to trim or otherwise modify the post. This not only enhances the bonding strength between the prosthodontic device and the root having received complete endodontic therapy, but also increases the stability and service life of the prosthodontic device. Moreover, the prosthodontic device simplifies the root-preserving and prosthodontic procedures following endodontic therapy and thereby contributes to improving the quality of related medical services and lowering the return visit rate.

### BRIEF DESCRIPTION OF THE SEVERAL VIEWS OF THE DRAWINGS

The foregoing and other technical features and effects of the present invention can be better understood by referring to the following detailed description of some illustrative embodiments in conjunction with the accompanying drawings, in which:

FIG. 1 is a perspective view of the prosthodontic device in the first embodiment of the present invention;

FIG. 2 schematically shows the remainder of a natural tooth to which the prosthodontic device in the first embodiment can be applied;

FIG. 3 to FIG. 5 show a series of assembly operations that put together the prosthodontic device in the first embodiment and the remainder of a natural tooth;

FIG. 6 is a perspective view of the prosthodontic device in the second embodiment of the present invention and a sleeve;

FIG. 7 schematically shows a plurality of prosthodontic devices according to the second embodiment mounted respectively in the remainders of a plurality of natural teeth and a denture applicable to and supportable by the prosthodontic devices;

FIG. 8 is a perspective view of the prosthodontic device in the third embodiment of the present invention; and

FIG. 9 schematically shows a plurality of prosthodontic devices according to the third embodiment mounted respectively in the remainders of a plurality of natural teeth and a denture applicable to and supportable by the prosthodontic devices.

### DETAILED DESCRIPTION OF THE INVENTION

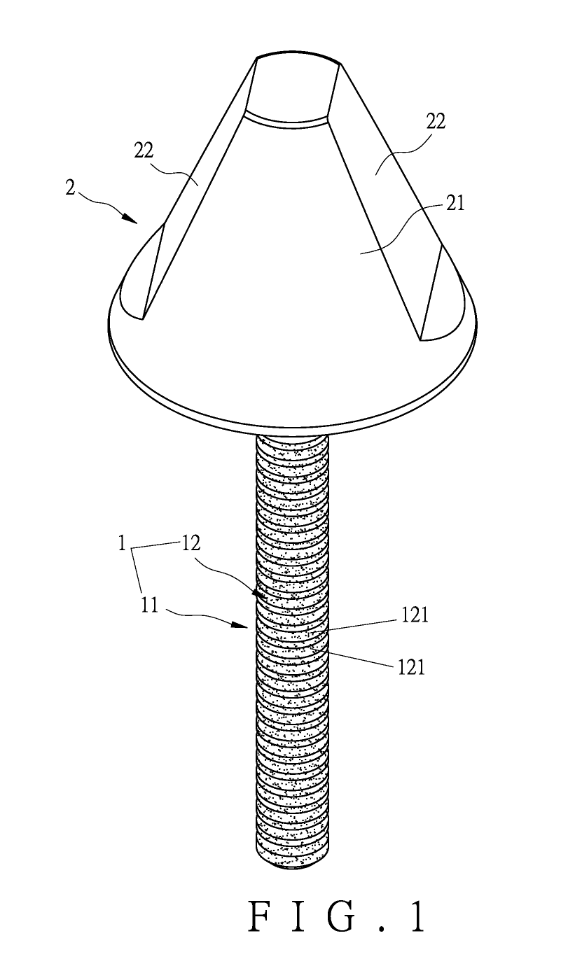

Referring to FIG. 1, the prosthodontic device in the first embodiment of the present invention includes a post 1 and a core 2. The post 1 has a post body 11 and a connection unit 12 formed on the surface of the post body 11. The connection unit 12 has a plurality of adjacent screw threads 121. The screw threads 121 in the present invention are not limited to concentric ones and may vary in configuration. The core 2 is integrally formed with the upper end of the post 1 and has a head 21 and at least one shoulder 22 formed on the head 21. The largest diameter of the head 21 is larger than the largest diameter of the post body 11 of the post 1. It should be pointed out that, while there are two shoulders 22 in this embodiment, the number of the at least one shoulder 22 is not limited to two. The shoulders 22 in this embodiment are inclined surfaces.

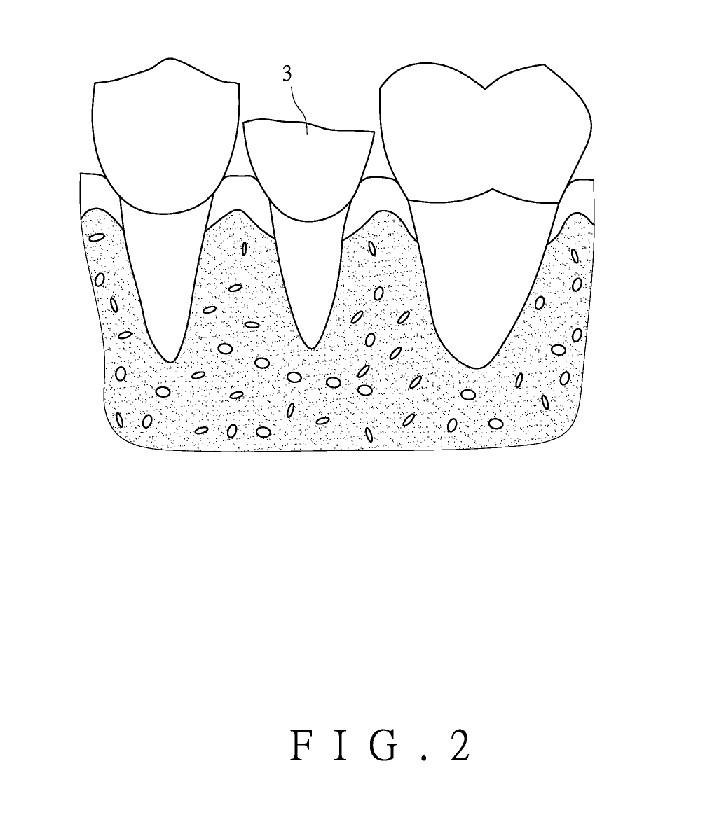

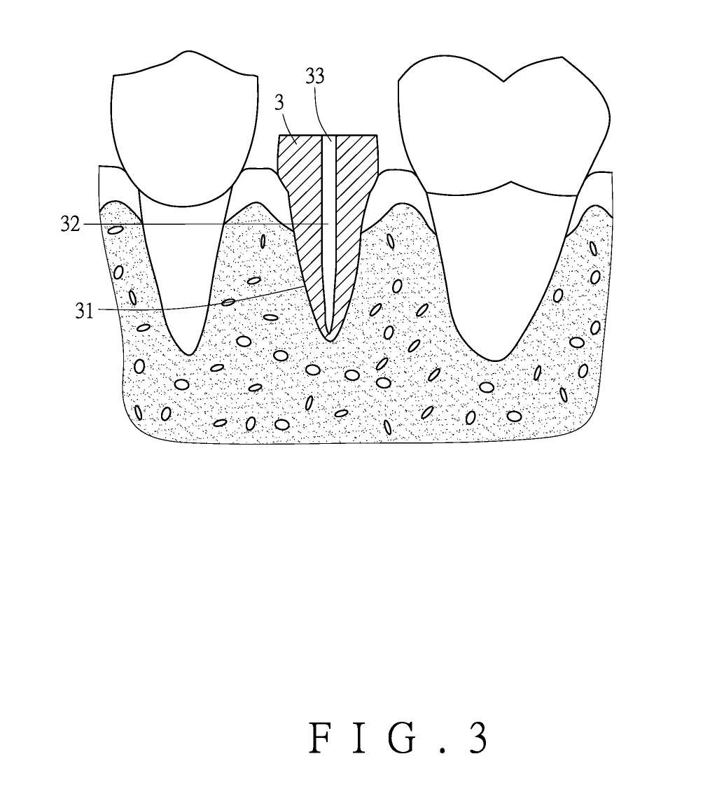

To use the prosthodontic device, referring to FIGS. 2, 3, and 4, it is imperative that the remaining natural tooth 3 to which the device is to be applied receive complete endodontic therapy first. During the therapy, the remaining natural tooth 3 will be particularly leveled, with as much sound dentin structure preserved as possible. Once endodontic therapy is completed, the tooth 3 has a sound root 31, a root canal 32 in the sound root 31, and an insertion hole 33 formed in the root canal 32.

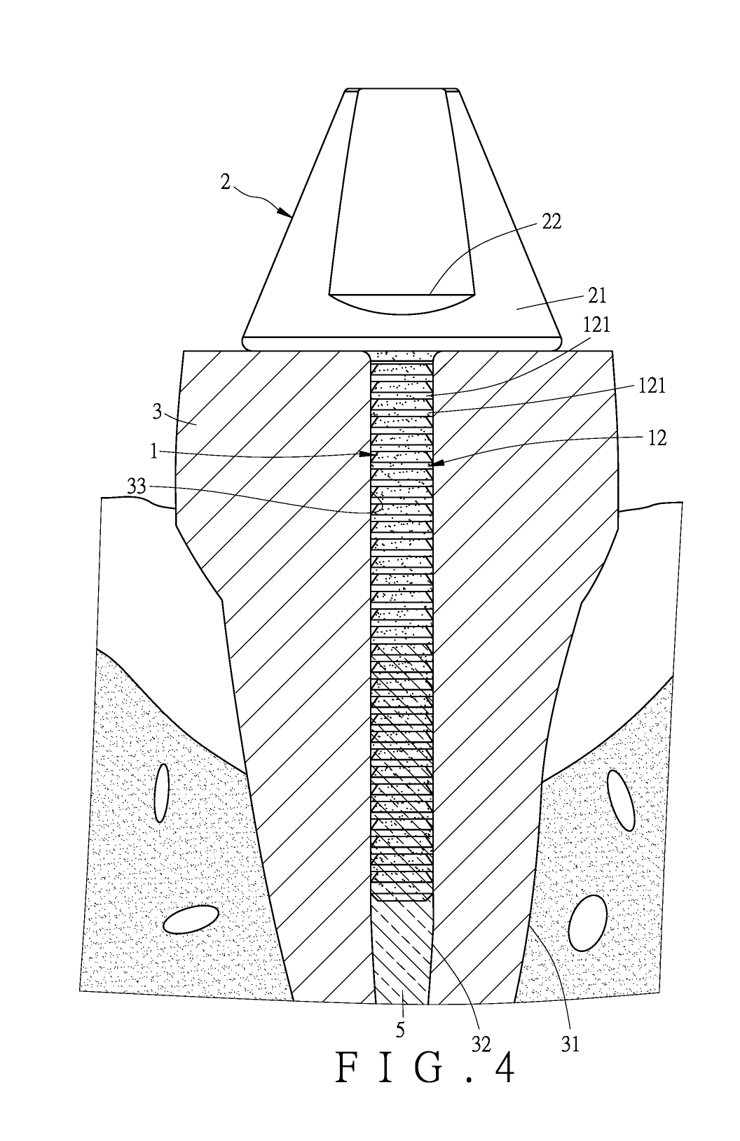

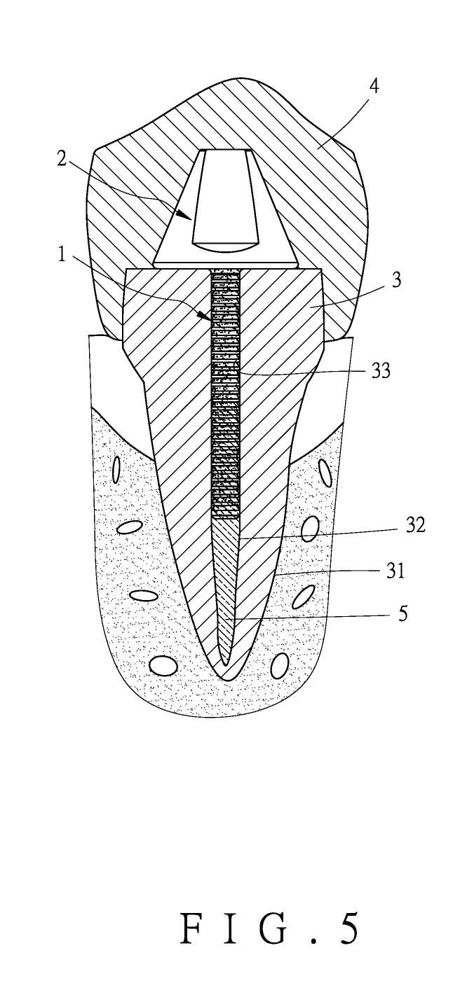

Referring to FIG. 4 and FIG. 5, the post 1 of the prosthodontic device is inserted into the insertion hole 33. Meanwhile, the screw threads 121 on the connection unit 12 are turned and consequently coupled with the wall of the insertion hole 33 in the root canal 32 having received complete endodontic therapy and are thus fixed in position mechanically. Alternatively, the insertion hole 33 in the treated root canal 32 may be filled with an appropriate amount of gutta-percha 5 first so that, when the screw threads 121 on the connection unit 12 are turned, fixation is achieved by an adhesive bond provided by the gutta-percha 5 as well as a mechanical bond. The latter approach enhances the bonding strength between the prosthodontic device and the wall of the treated root canal 32, increases the stability and service life of the prosthodontic device, and thereby ensures the success of prosthodontic procedures following the endodontic therapy.

Moreover, as the largest diameter of the core 2 is larger than the largest diameter of the post body 11 of the post 1, the core 2 will sit on the top end of the sound root 31 of the remaining natural tooth 3 after the post 1 of the prosthodontic device is secured in place. When it is time to take a precise impression of the core 2, therefore, the dentist does not have to trim or otherwise modify the core 2 of the prosthodontic device; a crown 4 can be prepared directly. Once the crown 4 is completed, the surface of the core 2 of the prosthodontic device is coated with adhesive, and the crown 4 is mounted on and thereby bonded adhesively to the core 2, which concludes the prosthodontic procedures on the root canal 32 having received complete endodontic therapy and the remaining dentin structure. The prosthodontic device helps simplify the entire treatment significantly, raise the quality of related medical services, and save the time required for such services.

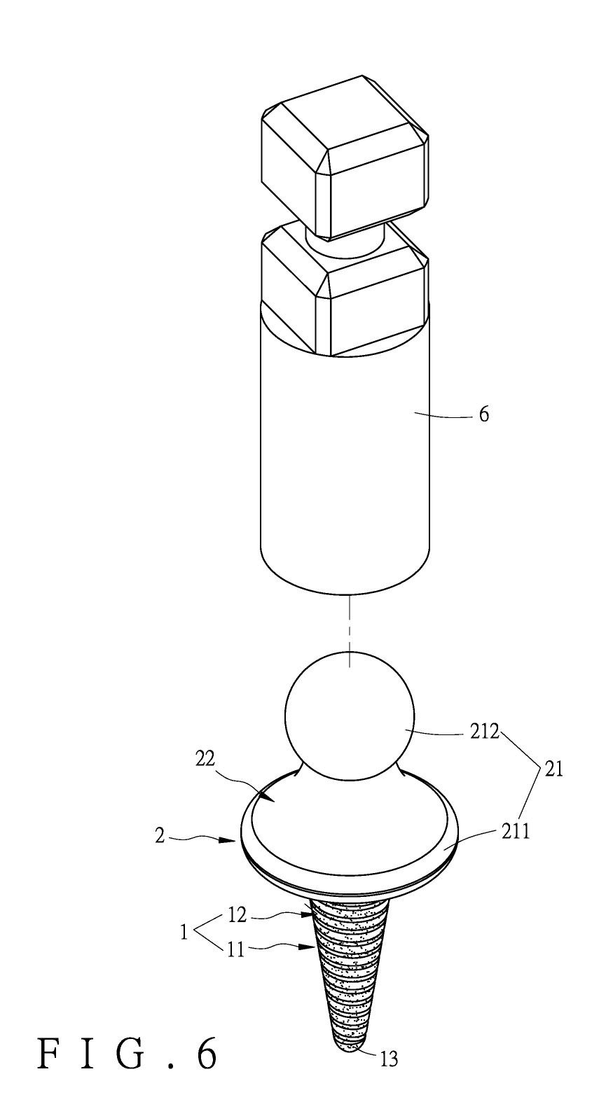

FIG. 6 shows the prosthodontic device in the second embodiment of the present invention. This embodiment is generally the same as the first embodiment except that the post body 11 of the post 1 of the prosthodontic device is conical and has a rough surface formed by sandblasting or other mechanical methods, that the post 1 has a blunt head 13 at the other end of the post body 11, that the connection unit 12 is configured as an external thread, and that the head 21 of the core 2 has a base 211 and a sphere 212 protruding from the top side of the base 211, wherein the top side of the base 211 tapers upward in a curved manner, starting from the periphery of the top side, and is eventually connected with the sphere 212. In this embodiment, there is one shoulder 22 by way of example, and the shoulder 22 is defined between the base 211 and the sphere 212.

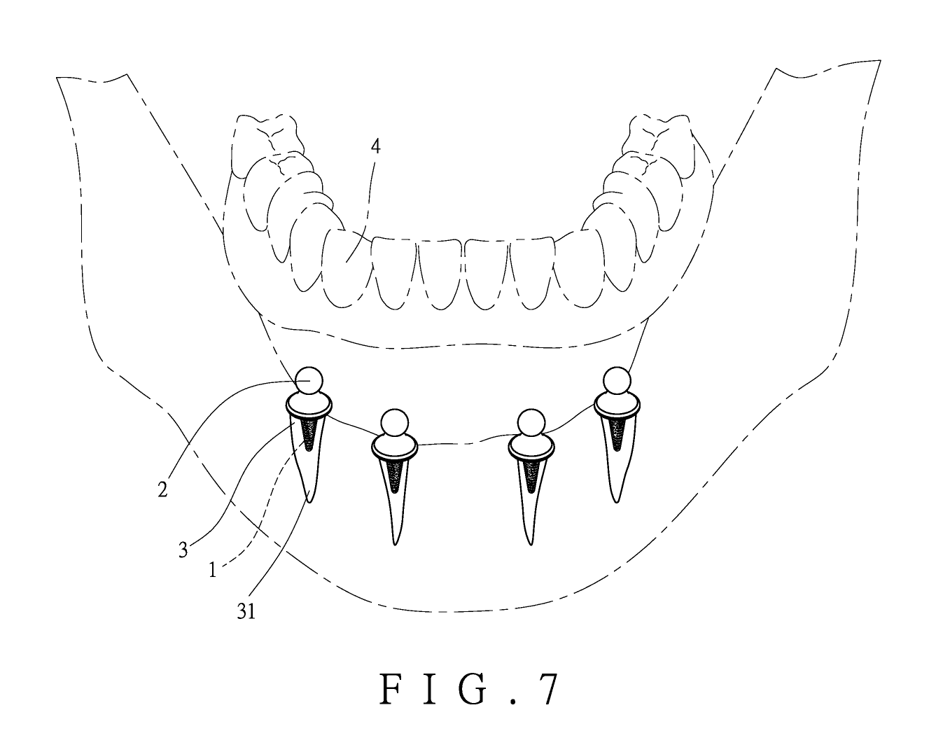

To use the prosthodontic device in this embodiment, referring to FIG. 6 and FIG. 7, the first step is to insert the post 1 of the prosthodontic device into the insertion hole 33 in the root canal 32 having received complete endodontic therapy. The design of the core 2 allows the dentist to mount a sleeve 6 around the head 21 of the core 2 and on the shoulder 22 of the core 2 in order to drive the prosthodontic device into rotation, thereby coupling the connection unit 12 of the prosthodontic device with the wall of the insertion hole 33 in the root canal 32 having received complete endodontic therapy. The rotation should stop when the post 1 of the prosthodontic device has penetrated about two thirds of the depth of the gutta-percha 5. It is worth mentioning that a dentist can operate the sleeve 6 with ease to rotate the prosthodontic device steadily forward in a spiral manner without idle rotation not only because the sleeve 6 is placed on the shoulder 22 defined between the base 211 and the sphere 212, but also because the top side of the base 211 of the core 2 tapers upward in a curved manner, starting from the periphery of the top side, and is eventually connected with the sphere 212. In addition, the conical structural design of the post body 11 of the post 1 of the prosthodontic device helps reduce the resistance encountered during forward spiral rotation, and the rough surface of the post body 11 of the post 1 of the device increases the friction between the post body 11 of the post 1 and the wall of the insertion hole 33 in the remaining natural tooth 3 having received complete endodontic therapy. The adhesiveness imparted by the gutta-percha 5 to the post 1 of the prosthodontic device also enhances the bonding strength between the post 1 of the prosthodontic device and the wall of the insertion hole 33 in the root canal 32 of the remaining natural tooth having received complete endodontic therapy. Apart from that, this embodiment is equally capable of increasing the stability and service life of the prosthodontic device, ensuring the success of prosthodontic procedures following endodontic therapy, and simplifying the prosthodontic procedures by eliminating the need for a dentist to trim or otherwise modify the core 2 of the prosthodontic device. Thus, the speed and quality of related medical services can be greatly improved, and the time required for such services, shortened.

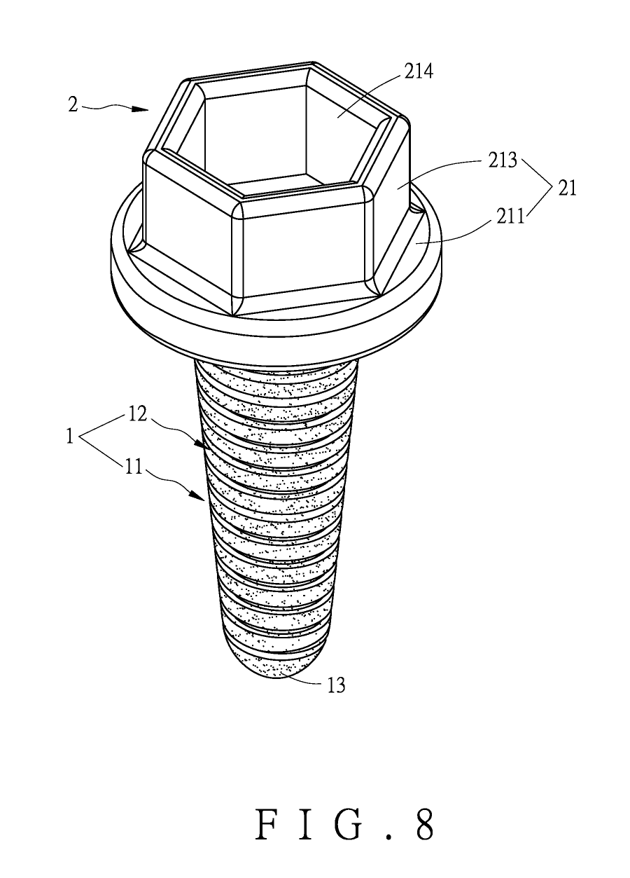

FIG. 8 shows the prosthodontic device in the third embodiment of the present invention. This embodiment is generally the same as the second embodiment except that the head 21 of the core 2 of the prosthodontic device has a polygonal protruding block 213 protruding from the base 211 and a recess 214 formed at the top end of the polygonal protruding block 213, wherein the contour of the recess 214 matches that of the polygonal protruding block 213. In this embodiment, both the recess 214 and the polygonal protruding block 213 are hexagonal, but it is not required that the recess 214 and the polygonal protruding block 213 are so shaped.

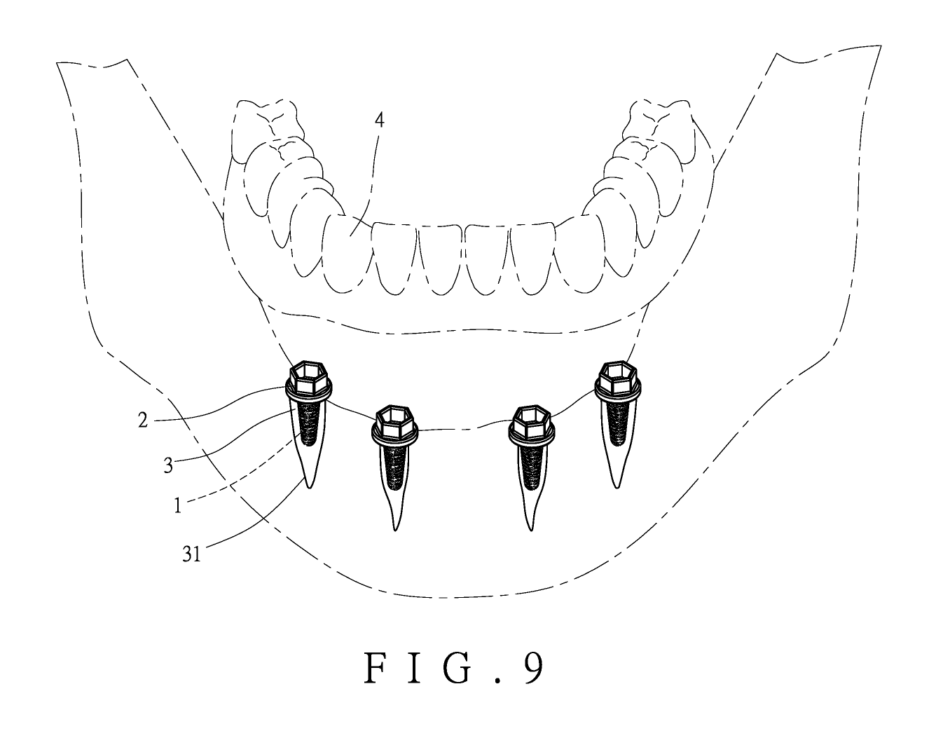

To use the prosthodontic device in this embodiment, referring to FIG. 8 and FIG. 9, a sleeve similar to that shown in FIG. 6 can be mounted around the recess 214 and on the shoulder 22 in order to rotate the prosthodontic device steadily forward in a spiral manner without idle rotation. With the post body 11 of the post 1 being conical and having a blunt head 13 and a rough surface as in the second embodiment, the resistance encountered during forward spiral rotation of the post 1 will be reduced, and the friction between the post body 11 of the post 1 and the wall of the insertion hole 33 in the root canal 32 having received complete endodontic therapy will be increased to enhance the bonding strength between the post 1 of the prosthodontic device and the wall of the insertion hole 33 in the remaining natural tooth 3. Thus, the prosthodontic device in the third embodiment produces the same results as its counterparts in the previous embodiments.

Furthermore, the prosthodontic device of the present invention can be used differently from the conventional cast dental posts. The prosthodontic device of the present invention is applicable to the treatment of not only a single tooth, but also multiple teeth. More specifically, referring to FIG. 9, when a patient is left with only a small number of unsound dentin structures in their mouth, restoration of an entire row of teeth can be carried out by performing endodontic therapy, among others if necessary, to preserve the aforesaid dentin structures and mounting the posts 1 of a plurality of the foregoing prosthodontic devices respectively into the remaining natural teeth 3 in the alveolar bone after the endodontic therapy is completed, wherein the mounting method can be any of those described above. It should be pointed out that, while the prosthodontic devices shown in FIG. 9 are of the configuration in the third embodiment, the same procedure is not limited to prosthodontic devices of this configuration alone; in other words, prosthodontic devices of the configuration in the first or the second embodiment may be used just as well. Once the posts 1 of the devices are fixed in position, the cores 2 sit respectively on the top ends of the sound roots 31 of the remaining natural teeth 3 having received complete endodontic therapy. An impression of the cores 2 of the devices can then be taken to enable production of the crowns 4 for the entire row of teeth. The finished crowns 4 are positioned on and adhesively bonded to the cores 2.

According to the above, the structural design of the prosthodontic device of the present invention makes it possible to dispense with the procedure of extracting a remaining natural tooth 3 that has received complete endodontic therapy. Moreover, the post 1 of the device can be directly locked in a root canal 32 having received complete endodontic therapy, thereby enhancing the bonding strength between the prosthodontic device and the wall of the root canal 32 having received complete endodontic therapy; as a result, the stability and service life of the prosthodontic device are increased. Not only that, a subsequent impression-taking operation can be performed by applying an impression material over the core 2 and then having the patient close their jaws. A dental impression for preparing the crown 4 can be made in this way without having to trim or otherwise modify the core 2. This simplifies the process of mounting a prosthetic tooth to a root canal 32 having received complete endodontic therapy, increases the speed and quality of related medical services significantly, and ensures the success of prosthodontic procedures following the endodontic therapy. The prosthodontic device of the present invention can also be used to restore teeth at various positions, i.e., without being limited by the position(s) of the root canal(s) 32 having received complete endodontic therapy. Thus, the prosthodontic device of the present invention features wide applicability.

It should be understood that the embodiments described above are only three preferred ones of the present invention. Those embodiments are not intended to be restrictive of the scope of patent protection sought by the applicant. All simple equivalent changes and substitutions made according to this specification and the appended claims should fall within the scope of the present invention.

What is claimed is:

1. A prosthodontic device applicable to a remainder of a natural tooth, wherein the remainder of the natural tooth has a sound root, a root canal in the sound root, and an insertion hole formed in the root canal, the prosthodontic device comprising:
a post having a post body and a connection unit, wherein the connection unit is formed on a surface of the post body and is configured to couple with a wall of the insertion hole; and
a core integrally formed with an upper end of the post and having a head and at least one shoulder, wherein the head is configured to sit on a top end of the sound root of the remainder of the natural tooth, the shoulder is formed on the head, and the core has a largest diameter larger than a largest diameter of the post body of the post.

2. The prosthodontic device of claim 1, wherein the post body of the post is conical, the surface of the post body is a rough surface, and the connection unit is configured as an external screw thread.

3. The prosthodontic device of claim 1, wherein the post body of the post is a straight column, the surface of the post body is a rough surface, the connection unit has a plurality of adjacent annular blocks, and the annular blocks are concentric and tapered.

4. The prosthodontic device of claim 2, wherein the post has a lower end formed with a blunt head.

5. The prosthodontic device of claim 2, wherein the head of the core has a base and a sphere; the base is configured to sit on the top end of the sound root of the remainder of the natural tooth and has a top side; the sphere protrudes from the base; the top side of the base tapers upward in a curved manner, starting from a periphery of the top side, and is eventually connected with the sphere; and the shoulder is located between the base and the sphere.

6. The prosthodontic device of claim 4, wherein the head of the core has a base and a sphere; the base is configured to sit on a top end of the remainder of the natural tooth and has a top side; the sphere protrudes from the base; the top side of the base tapers upward in a curved manner, starting from a periphery of the top side, and is eventually connected with the sphere; and the shoulder is located between the base and the sphere.

7. The prosthodontic device of claim 4, wherein the head of the core has a base, a polygonal protruding block, and a recess; the base is configured to sit on a top end of the remainder of the natural tooth; the polygonal protruding block protrudes from the base; the recess is formed at a top end of the polygonal protruding block and has contour matching a contour of the polygonal protruding block; and the shoulder is located between the base and the polygonal protruding block.
